(19) United States
(12) Patent Application Publication
(10) Pub. No.: US 2004/0147215 A1
(43) Pub. Date: Jul. 29, 2004

(54) Air distribution device

(76) Inventor: Bernt Nystrom, Stockholm (SE)

Correspondence Address: OSTROLENK FABER GERB & SOFFEN, 1180 AVENUE OF THE AMERICAS, NEW YORK, NY, 100368403

(21) Appl. No.: 10/477,226

(22) PCT Filed: May 6, 2002
(86) PCT No.: PCT/SE02/00867

(30) Foreign Application Priority Data
May 7, 2001 (SE) 0101578-3

(51) Int. Cl. B01L 1/04

(52) U.S. Cl. 454/187

(57) ABSTRACT

Air distribution device (4) provided with an inlet opening (5a) and at least one outlet opening (8) for conveyance of air from a fresh air area (21) to at least one ventilation area (24) in an air volume (LV) limited by floor (1), walls (2) and ceiling (3), said fresh air area (21) being situated along the floor in the air volume (LV), the distribution device (4) being arranged to locally supply fresh air from the fresh air area (21) to a near zone of the respiratory organ of an individual in the air volume (LV).

### TECHNICAL FIELD OF THE INVENTION

The present invention relates to a distribution unit as a complement to a supply air terminal unit through which fresh air is supplied to a room volume.

### BACKGROUND OF THE INVENTION

Existing supply air terminal units are formed to provide an air volume with fresh air by being dimensioned to exchange the entire air of the air volume during a determined period of time. Thus, larger supply air terminal units and larger ventilation plants are required for large air volumes than for small air volumes. Naturally, it is associated with large costs to dimension and install as well as operate a large ventilation plant in comparison with a small plant. An additional cost implication is also temperature factors, cooling factors, filtering, ionization factors and moisture on the supply air, which all factors drastically increase the costs at large plants in comparison with small plants. Furthermore, conventional supply air terminal units are intended to enable ventilation of an air volume so that the fresh air will be reasonably evenly distributed in the volume, which conduce to primary parts in the air volume not becoming better ventilated than secondary parts of the same.

### OBJECT OF THE INVENTION

The present invention aims at providing a ventilating device in order to enable improved ventilation in a limited primary part near a working place in an air volume, a so-called near-zone ventilation.

An additional object is to provide a manually directable ventilating device for primary ventilation, a so-called near-zone ventilation, in an air volume.

Furthermore, the object is to enable a unique treatment of air in such a ventilating device in order to additionally increase the air quality in this primary part of the air volume by aftertreating the air before it is let out in the primary near zone.

Furthermore, the object is to obtain satisfactory ventilation at a working place with large cost savings in comparison with conventional ventilation plants.

An additional object is to transport fresh air from a fresh air area to at least one ventilation area for ventilation in a near zone of a working place in an air volume.

### SUMMARY OF THE INVENTION

By means of the present invention, as this stands out in the independent claim, the above-mentioned objects are met, said disadvantages having been eliminated. Suitable embodiments of the invention are given in the dependent claims.

Premises having a desk-located activity and general ventilation may obtain an individual climate by a working place-based air treatment. Supply air temperature and flow are adjusted to the desired rate within the scope of the available capacity.

The air distribution device according to the invention is provided with an inlet opening and an outlet opening for distributing fresh air in a primary part of an air volume.

The inlet opening of the device is located at floor level, i.e. 5-30 cm, preferably 10-20 cm, above the floor surface, so as to, at that position, by means of a fan, “fetch” the fresh air which, via supply air terminal unit connected to a central ventilating system, distributes fresh air along the floor. The fetched fresh air is then distributed via a flexible distribution duct to the outlet opening of the device, which in the embodiment illustrated is provided with at least one articulatable or bendable nozzle. By this design, a flexible ventilating device is obtained, which is not dependent on connection to a central ventilating system but may be placed at an optional location in the air volume.

Furthermore, the supply air device is, in the embodiment illustrated, free-standing from the limiting surfaces of the air volume, i.e. it is not placed on floor, walls or in the ceiling. The supply air device is in this connection provided with fastening members arranged to fasten the supply air device at an object that is placed within the air volume, e.g. underneath a table. Furthermore, a fan is placed in front of, counted in the direction of flow, a particle filter in the device in order to “suck” out filtered fresh air in the air volume.

Furthermore, the device may be provided with one or more detachable supplementary modules, which are placed in a fastener adapted for the module in the device. The supplementary modules are provided with a radiator, a cooling coil, a moistening element, an ionization element, a filter element, a scent element or a combination of one or more of these elements with the purpose of influencing the fresh air flowing through the modules. It is thereby possible to manually bypass one or more modules by easily accessed control members. Filter units are placed either at the inlet opening before the pump or as a supplementary module or as a separate filter at an outlet opening. Also combinations of these filter arrangements are feasible.

A supplementary module is in the described embodiment shaped as a right parallelepiped but may within the scope of the claims also have other shapes.

### BRIEF DESCRIPTION OF THE DRAWINGS

The invention will now be described closer by means of embodiment examples, reference being made to the accompanying drawings, in which

FIG. 1 shows a skeleton diagram of an embodiment of the invention.

FIG. 2 shows schematically an end view of the invention placed under a desk.

FIG. 3 shows schematically a side view of the invention according to FIG. 2.

FIG. 4 shows schematically a planar view of an embodiment according to the invention installed under a conference table for eight persons.

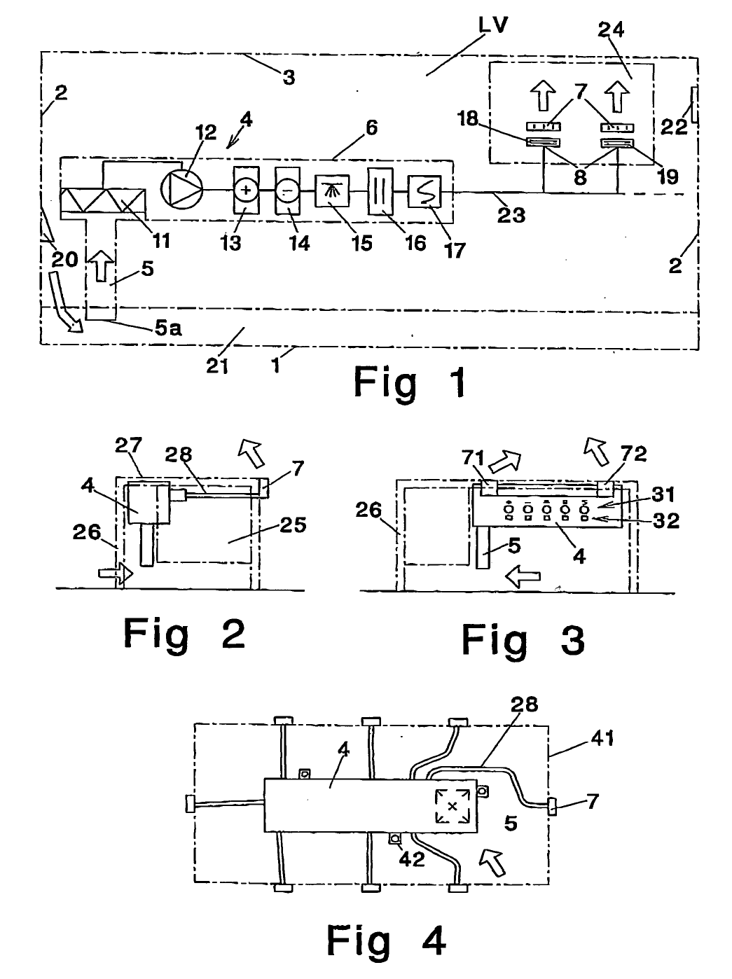

### DESCRIPTION OF THE INVENTION

In an air volume LV that is limited by a floor 1, walls 2 and a ceiling 3, a distribution device 4 is mounted. The device consists of an inlet unit 5 having an inlet opening 5a. Furthermore, in the direction of flow the device consists of a main unit 6 including a main filter 11 in class F=8-11, a pump 12 as well as a number of supplementary modules 13, 14, 15, 16, 17. It should be emphasized that also the main filter 11 may be formed as a supplementary module. A first supplementary module 13 is provided with a radiator intended to heat the fresh air flowing through the module. A second supplementary module 14 is provided with a cooling coil intended to cool the fresh air flowing through the module. The heating and cooling capacity, respectively, for these modules is ±5-8° C. from the supply air temperature in question. A third supplementary module 15 comprises a moistening element intended to moisten the fresh air flowing through the module with up to 3 g/kg. A fourth supplementary module 16 comprises a scent generator intended to give the air flowing through a certain scent. A fifth supplementary module 17 is provided with an ionization element intended to ionize the fresh air flowing through the module with negative air ions.

Furthermore, the device comprises a number of connected spraying nozzles 7 that are provided with nozzle modules arranged at each outlet opening 8, a first nozzle module 18 being arranged as a particle filter adapted to individual performance while a second nozzle module 19 is arranged as a scent filter 19 adapted to individual performance. The pump 12 provides a variable airflow of 2.0-6.0 l/s for each nozzle.

The function of the distribution device 4 is that fresh air is supplied to the air volume LV through a supply air terminal unit 20 by an air flow going down to the floor 1, a fresh air area 21 being formed along the floor. Above this fresh air area, a mixing of fresh and used air takes place successively but relatively slowly so as to eventually flow out from the air volume through an exhaust air terminal unit 22. The inlet opening 6 of the inlet unit 5 is located in the fresh air area 21. Fresh air is sucked up by means of the fan 12 and further on through the main unit 6 with its main filter 11 and its installed modules 13, 14, 15, 16, 17 and further out via distribution ducts 23 through articulatable or bendable spraying nozzles 7. The target for this distributed fresh air, which possibly has been treated in one or more modules, is a local near zone 24 in the vicinity of the respiratory organ of an individual in the air volume LV. Successively, also this locally distributed air is mixed with used air so as to eventually be pressed out through the exhaust air terminal unit 22.

FIG. 2 shows an end view of an office desk 26 provided with a pedestal 25, under the table top 27 of which desk a distribution device 4 according to the invention is mounted. As the arrows show, fresh air is sucked in from the floor level up through the device and further out through the spraying nozzle 7. The spraying nozzle 7 is in this connection placed out at the side edge of the table 26 and connected to the device via air hoses 28 while the distribution device 4 is located in under the table in order not to be in the way for the legroom. Furthermore, it is seen from the angled arrow in the figure that the spraying nozzle 7 is directable.

FIG. 3 shows a corresponding office desk 25 as in FIG. 2, but shown from the long side thereof, the manual control of the distribution device being seen from the front side thereof. The control comprises a quantity unit 31 that controls the amount of heat, cold, moistening, scent and ionization. Furthermore, the control comprises a bypass unit 32 for each supplementary module. The figure also shows the air flow from the floor level in through the inlet unit 5, through the distribution device 4 and out through two spraying nozzles 71, 72. Correspondingly as has been shown in FIG. 2, the spraying nozzles are directable which is evident from the angled air arrows in the figure.

FIG. 4 shows a conference table 41 for eight persons that is provided with a distribution device 4 according to the present invention. From the inlet unit 5, fresh air is supplied according to what has previously been described. The air is distributed by means of the distribution device 4 to spraying nozzles 7 to all eight working places via air hoses 28.

In all embodiments, the inlet opening 5a is placed at a relevant distance from the floor surface which is dependent on the location of the supply unit in terms of the distance and direction to the inlet opening 5a as well as the air flow through the supply air terminal unit. Furthermore, all embodiments are provided with fastening members 42 with which the distribution device 4 is mounted on interior fittings, e.g. tables, in the air volume.

1. Air distribution device (4) provided with an inlet opening (5a) and at least one outlet opening (8) for conveyance of air from a fresh air area (21) to at least one ventilation area (24) in an air volume (LV) limited by floor (1), walls (2) and ceiling (3), characterized in that said fresh air area (21) is situated along the floor arranged to be delivered by a central ventilation system via a supply air terminal unit to in the air volume (LV), the distribution device (4) being arranged to locally supply fresh air from the fresh air area (21) to a near zone of the respiratory organ of an individual in the air volume (LV).

2. Device according to claim 1, characterized in that the distribution device (4) is freestanding from the limiting surfaces of the air volume (LV) by being mounted on interior fittings (26) in the air volume.

3. Device according to any one of claims 1-2, characterized in that a fan (12) is located in the device in order to suck air through the inlet opening (5a), through one or more ducts in the device and further out via distribution ducts (23) through the outlet opening (8).

4. Device according to claim 3, characterized in that the inlet opening (5a) is located at the floor (1) of the air volume at a distance of 5-30 cm from the floor surface.

5. Device according to any one of claims 1-4, characterized in that the outlet opening (8) is provided with at least one articulatable or bendable spraying nozzle (7).

6. Device according to claim 5, characterized in that at least one detachable supplementary module (13, 14, 15, 16, 17) is located in a fastener in the device, which fastener is adapted for the module (13, 14, 15, 16, 17), so that the module brings about that the air flowing through the device (4) passes through the module (13, 14, 15, 16, 17).

7. Device according to claim 6, characterized in that a manually adjustable bypass unit (32) and/or a manually adjustable quantity unit (31) is connected to at least one supplementary module (13, 14, 15, 16, 17) in order to enable the airflow to pass beside thereof.

8. Device according to any one of claims 6-7, characterized in that the supplementary module (13, 14, 15, 16, 17) is provided with either a moistening element (15), a radiator (13), an ionization element (17), a cooling coil (14), a scent element (16, 19) or a particle filter (11, 18).

9. Device according to any one of claims 1-8, characterized in that the is device is provided with fastening members (42) arranged to attach the device at the under side of a table (26) placed in the air volume (LV).

10. Device according to claim 9, characterized in that the device is provided with eight bendable spraying nozzles (7) placed at the side edges of a rectangular table (41) such that three nozzles are placed at one long side of the table and three at the other long side thereof while one nozzle each is placed at the respective short side of the table.
